(19) United States
(12) Patent Application Publication
(10) Pub. No.: US 2024/0117548 A1
(43) Pub. Date: Apr. 11, 2024

(54) A NEW INDUSTRIAL WASHING SYSTEM

(71) Applicants: Realkom Tekstil Urunleri Sanayi Pazarlama Ve Dis Ticaret Anonim Sirketi, Eyup, Istanbul (TR); Real Solutions Bilisim Teknolojileri Sanayi Ticaret Anonim Sirketi, Duzce (TR)

(72) Inventors: Furkan UNGOREN, Umraniye, Istanbul (TR); Bisar ALPAGUT, Duzce (TR)

(21) Appl. No.: 18/263,773

(22) PCT Filed: Feb. 2, 2022
(86) PCT No.: PCT/TR2022/050093

§ 371 Date: Aug. 1, 2023

(30) Foreign Application Priority Data
May 1, 2021 (TR) 2021/007455

(51) Int. Cl. D06F 34/05; D06F 31/00; D06F 33/30; D06F 34/28; G05B 19/042; G05B 19/05

(52) U.S. Cl. CPC D06F 34/05; D06F 31/00; D06F 33/30; D06F 34/28; G05B 19/042; G05B 19/05; D06F 2105/58; G05B 2219/2633

(57) ABSTRACT

Disclosed is a system into which barcode software, SCADA, operator monitoring software and the interfaces are integrated, for the industrial textile washing systems having at least one washing machine. In particularly, a system and a method are disclosed which allow the operation to be realized upon approval of an operator by displaying the washing recipes defined based on a product on a screen and minimized the work load of the operator.

### SUBJECT OF THE INVENTION AND TECHNICAL FIELD

This invention relates to a system into which barcode software, SCADA, operator monitoring software and the interfaces are integrated, for the industrial textile washing systems comprising at least one washing machine. In particularly, the invention relates to a system and a method, which allows the operation to be realized upon approval of an operator by displaying the washing recipes defined based on a product on a screen and minimized the work load of the operator.

### STATE OF THE ART

Today, all industrial plants accommodate a plurality of machines. Some of these machines are able to conduct very simple operations, while the others conduct very complicated operations. Each machine comprises various motors, hydraulic-pneumatic systems and sensors. Devices which allow these devices to work in harmony with each other, distribute their duties, signals their failure and set their timings are called PLCs (Programmable Logic Controller). PLC may control and signal very complicated systemic operations. The main purpose for using PLCs is to prevent the operation of the machines from being intervened by humans, to minimize the errors and to increase the continuity and speed.

PLC consists of for main sections: a central processor unit (CPU), a memory unit, inputs and outputs. The central processor unit performs the duties of PLC, such as logical operations, timing, counting, comparing, etc. The central processor unit (CPU) is the brain of PLC. The program of PLCs is stored in the memory unit. Data therein are sent to CPU. The memory of the PLC is erasable and rewritable. The inputs consist of the digital and analog data applied to the input. Data of the members are entered into the inputs, such as sensors, switches, keys, buttons, limit switches, pressure switches, level switches, pressure switches, temperature switches, etc. Outputs consist of the digital and analog data obtained from the output. The valves, solenoids, actuators, engine starters, alarms, lights, counters, pumps and fans may be controlled via the outputs.

In the state of the art, the mode of operation of the PLC is generally as follows: The input data is read, and these values are saved in memory as 1 or 0. Then, the input data is interpreted according to the program written and uploaded. Subsequently, it is obtained from the output as 1 or 0. A motor may be started and stopped according to the scenarios assigned by interpreting the data obtained from the input sensors.

On the other hand, SCADA (Supervisory Control And Data Acquisition) systems are frequently used in the automation systems. SCADA is a data collection and control system which obtains the application data from the programmable logic controllers (PLC), distributed control systems and sensors, which are located in businesses, and evaluates them in real-time in a continuous manner, wherein the system provides the necessary information to a user by the warning messages and allows various factors which negatively affect the production process to be monitored from a single center as a graphic or trend and to be controlled remotely. By means of SCADA control systems, all units may be automatically controlled and monitored, including control and production planning of all equipment in a plant or business, environment controlling units and utility services.

In the state of the art, implementations of automation systems which comprise SCADA and PLCs exist in the textile industry.

The Turkish patent no. 2008/00800, entitled “Data Tracking, Collecting and Controlling System” discloses a system which may remotely monitor and control a given device or plant. By means of the data tracking PC (SCADA) in the system, the authorized persons in various departments of the businesses which perform manufacturing processes in the textile industry may observe the quantity of water, steam, natural gas and electric energy spent by the machines per day, month or year with a user name and password via a local network or Internet by attaching an electric meter (15), a natural gas meter (16), a water meter (17) and a steam flow meter (18) to the power input of a powder paint storing machine (10), a printing paste preparing machine (11), a fabric drying and ram machine (12), a fabric cleaning machine (13), a fabric dyeing machine (14) and the other machines to be measured in the businesses.

The Turkish patent no. 2011/01413, entitled “A check method for washing machines” relates to recording and controlling the counts of cycles in the washing program of the washing machines during operation. The check method of the invention comprises the steps of checking whether the selected washing program cycle has been completed or not; if said cycle has not been completed, checking whether this cycle has been canceled by the user or not; if said cycle has been canceled, checking whether or not the cycle has been terminated due to a malfunction.

The patent document no. 2020/10396, entitled “A multi-functional automated reactional guided autonomous tool synchronized with the industrial machines in a factory and an automation system therefor” relates to an automation system which may carry out the logistical loading, unloading, carrying and weighting processes of the denim and made-up products in the industrial washing, drying and squeezing machines, which are used in textile finishing industries, and an automation system in which an automated reactional guided tool developed for that system is used.

U.S. Pat. No. 10,294,600B2, entitled “Remote detection of washer/dryer operation/fault condition” discloses a system comprising a micro-electronic-system (MEMS) sensor. Said system detects the operating condition of clothes washing machine or a clothes drying machine.

The Chinese patent no. CN101397736A, entitled “Washing machine capable of automatic adding washing agent based on standard and laundry method with washing agent addition” relates to a washing machine that can automatically add a washing agent according to the factors, such as weight of clothes, degree of dirtiness, cloth quality, and temperature of water used.

The Chinese patent no. CN102808303A, entitled “Washing machine system based on digital operation” discloses a washing system comprising PLCs. The object is to have a fully automatic washing machine.

There are studies on the digitalization of the washing machines in the patent-utility model implementations in the state of the art. However, these studies provide improvements in a single washing machine, rather than the industrial systems involving more than one washing machine. There is a need for studies for the digitalization of the washing machines in the systems involving more than one industrial scale washing machines.

In the state of the art, a recipe is prepared in order to be able to wash the products in the washing machines in the businesses where the industrial washing processes are performed. The washing information for the product (an enzyme wash for 40 min., neutral for 15 min., at a temperature of X ° C., at a revolution of Y and with a Z chemical) is present in the recipes prepared. The recipe prepared is delivered to the operator.

The operator enters and sets the information written in the recipe step by step. The machine operates according to the set values. In this step, the errors made by mistake are inevitable. The errors made by mistake cause a big problem for the manufacturing process. The reason for this that a plurality of products is present in the machine, and when the washing process is performed under inappropriate conditions, the color and the extent of wearing of the product will be affected, so that the product has become a defective product.

In the state of the art, the facts that the operator is not able to follow the steps in the washing recipe in an appropriate manner and to enter the values in the recipe to the machine correctly; the amounts of water and chemical are not determined correctly; the unit cost of the product cannot be calculated and monitored instantly based on the recipes; the operation time of the machines cannot be detected and the productivity of the machines and the operator cannot be estimated, need to be improved. On the other hand, there is a need for a system which monitors the number of the products output from the machines independently, monitors the OEE (Overall Equipment Effectiveness) calculations digitally and instantly, provides an instant monitoring of the maintenance-repair processes of the machine and detects the reasons of the malfunction of the machines correctly.

### Technical Problems to be Solved by the Invention

By means of the system of the invention, the software and machine learning artificial intelligence are intended to be improved, which control the operation as well as the instant monitoring of the washing machines in the industrial scale businesses. The object of the invention especially is to provide a system which allows which product is washed in which washing machine according to which recipe to be recorded and minimizes the need for an operator, wherein the barcode software, SCADA, operator monitoring software and interfaces may be integrated into the system.

The most important advantage of the system according to the invention is that the system provides a human-machine, human-method, machine-method and material-machine matching, so that a remote control is provided after the data is received and sent to the cloud system.

One advantage of the system according to the invention is that the system is able to monitor the operation time of a plurality of machine only by an administrative personnel via the interface program. In the state of the art, the operation time of the machines is determined by the operator.

An advantage of the system according to the invention is to monitor the efficiency instantly by means of the reporting displays on the interface. In the state of the art, the operation time of each machine and the working hours of each personnel are assessed, and the OEE (Overall Equipment Effectiveness) analyses are monitored by the engineers.

One advantage of the system according to the invention is that the system allows monitoring the performance of the operator based on the loading of the products, the control of the products in the machine, the monitoring of the start and end control of the machines, etc. In the state of the art, these actions are monitored by their administrators. By means of the system of the invention, each personnel and their duties are monitored via the reporting displays.

An advantage of the system according to the invention is to allow the reporting display to be seen by the instant production plans being integrated into the operation of the machines. In the state of the art, the instant production planning is made by the administrators depending on the fill rate of the machines.

An advantage of the system according to the invention is that the reasons of malfunction of the machines are displayed on a display. In the state of the art, the data of the machine stopping caused by a malfunction are monitored by the personnel. (For example, determining the data based on a given maintenance time, such as a decrease in the temperature of water, failure of water to enter the machine, etc.). A rapid intervention will be possible and waste of time will be avoided as the reasons of the malfunction are displayed on the display.

One advantage of the system according to the invention is that the operator will not enter the recipe information (temperature, chemical, detergent, etc.). In the system of the invention, the recipe information will be sent to the machines as an instruction, and the possibility of the operator to enter the reaction information erroneously will be avoided. The deformations in the product caused by erroneous entry of the recipe information, such as color deformations, wear, etc. will be avoided, thereby financial losses arising from the defective products will be prevented.

In order for the system of the invention to be better understood, the reference will be made to the following drawings.

### DESCRIPTION OF THE DRAWINGS

FIG. 1 is a scheme showing the main components of the system according to the invention.

FIG. 2 is a drawing showing the components of the electronic device in the system according to the invention.

FIG. 3 is a flow chart demonstrating the work flow in the system according to the invention.

### REFERENCE NUMERALS OF THE SECTIONS, PARTS AND FLOW FOR DESCRIBING THE INVENTION

1—Washing machine
2—PLC
3—Fixed server
4—Central server
5a—User display
5b—Main display
6—Electronic device
7—Regulator
8—Power jack (DC Power Jack)
9—Condenser
10—RFID antenna socket
11—RFID reader module
12—Programming jumper
13—Programming socket
14—Wifi module
15—Buzzer sound alarm
16—Reset button
17—Programming button
18—Automatic reset jumper
19—Power led
20—Wifi connection led
21—Status led

### Process Flow Chart to Help Describing the Invention

100—Turning on the machine and enabling the electronic device,
110—Turning on the WiFi module,
120—Making the wireless network connection and requesting scanning of the card from the operator,
130—Scanning the card by the operator and sending the card information to the server,
140—Scanning the barcode of the product and sending the product information to the server,
150—Approving the recipe,
160—Loading the products and starting the washing process,
170—Loading the chemicals,
180—Unloading the products.

### Detailed Description of the Invention

The system of the invention is intended to be a system in which the textile washing machines are monitored instantly and the analyses performed by the personnel are reported by the machines due to the machine learning. In particularly, the invention allows the washing recipes defined for the product to be automatically displayed on the user display (5a) and the operation to be performed upon the approval of the operator, thereby minimizing the work load of the operator. To this end, the processes which are required to be controlled and observed in the production plant are determined, and the system is controlled by the PLC member in the washing machines and the interface software developed. The electronic and software system of the invention may be applied to all areas of textiles, including the production plants for denim trousers, or to the non-textile areas. Although the system of the invention is described as a washing machine (1) and a washing system, it generally includes the textile machines, or a machine tool or workbench.

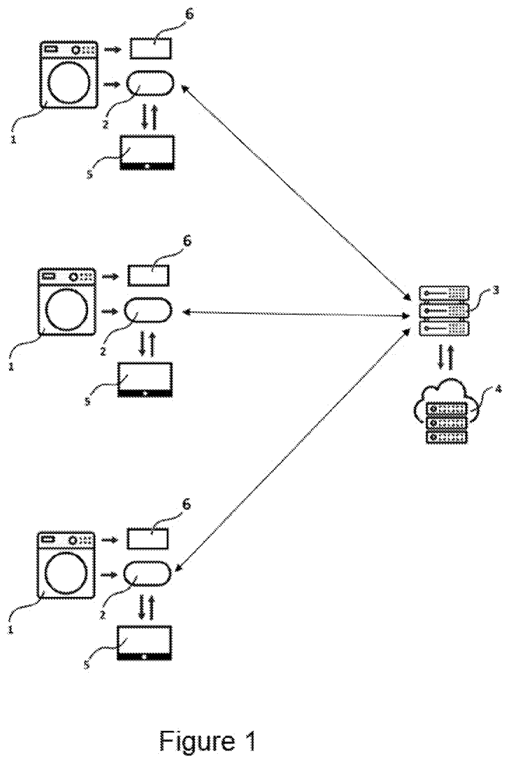

FIG. 1 shows a scheme depicting the components of the system according to the invention. Accordingly, the invention generally comprises at least one washing machine (1), a PLC (2) system which controls both said washing machine (1) and the operation and is located in said washing machine (1), at least one electronic device (6) connected to said PLC (2) system and the washing machine (1), which manages said washing machine (1) during the check (approval) of an employee, at least one user screen (5a) on which the outputs, such as a recipe, a written warning, etc., are displayed, wherein the user screen is connected to said electronic device (6) and the PLC (2) system, at least one wired or wireless fixed server (3) which sends and receives information to/from said washing machine (1), at least one central server (4) connected to said fixed server (3), at least one database in which the recipe and operation information, including the engine speed, operation time, temperature, driver errors, step information, etc., is stored, in said fixed server (3) and thus, in the central server (4), and at least one main screen (5b) connected to said central server (4).

FIG. 1 shows a system comprising three washing machines. However, it should be known that this is not limiting. The electronic and software system of the invention may be applied to all systems comprising at least one washing machine (1). In the system, there exist an IP (Internet Protocol) number for each washing machine, as well as a PLC (2) and the user displays (5a), which have those IP (Internet Protocol) numbers. Said PLC (2) system comprises a MODBUS TCP or PROFINET communication protocol. The central server (4) may be omitted for the application of the system according to the invention in small businesses, and in this case only a fixed server (3) may be present. The fixed server (3) may be connected to the cloud system.

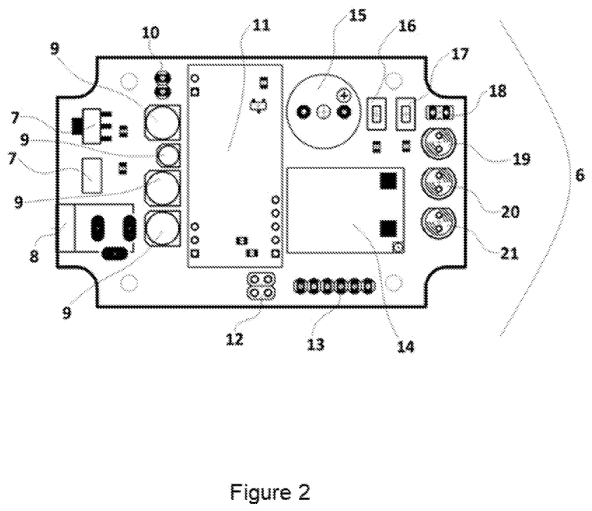

The system of the invention comprises at least one electronic device (6) which manages the washing machine (1) under the control (approval) of an employee. FIG. 2 shows said electronic device (6) and the components thereof. Accordingly, said electronic device (6) comprises at least one regulator (7) which provides protection against overheating; at least one power jack (8) which provides the necessary power input to the card; at least one condenser (9) which actuates said regulator (7) integrations and also minimizes the voltage fluctuations and the noises in the circuit; at least one RFID reader module (11) which reads the RFID cards; at least one RFID antenna socket (10) which connects the RFID reader antenna of the RFID reader circuit and so, allows the position of the antenna to be adjusted; at least one wifi module (14) which controls the card and makes the wifi connection by programming the microcontroller therein, wherein the wifi module sends/receives data to/from the Internet; at least one programming jumper (12) which, when said wifi module (14) is programmed, disconnects the serial communication therebetween with the RFID reader module (11) and itself; at least one programming socket (13) by means of which the programmer necessary for programming said wifi module (14) is attached to the card; at least one buzzer sound alarm (15) which informs a user of a successful scanning process by providing a sound when the card is scanned; at least one reset button (16) which resets said wifi module (14) and operates the system again; at least one programming button (17) which enables said wifi module (14) to enter the programming mode; at least one automatic reset jumper (18) which provides the connection necessary for awaking said wifi module (14) again when it enters the sleep mode for power save; at least one power led (19) which informs a user of the power provided to the system; at least one wifi connection led (20) which informs a user of the connection of said wifi module (14) to the designated wifi network; and at least one status led (21) which informs a user of a successful scanning process of the RFID card and the operating status of the system. The locations and numbers of the components indicated in FIG. 2 may vary. In this sense, it should be known that the figure is not limiting. For example, there are more than one regulator (7) in FIG. 2. Preferably, at least two regulators (7) are used in the system of the invention. One of the regulators (7) is preferably a linear regulator of 3.3V/800 mA. It has a tolerance of 0.2%. It limits the voltage applied to the input to 3.3 Volts, and an input of maximum 12V is provided. The second regulator (7) is preferably a linear regulator of 5V/1A. It has a tolerance of 2%. It limits the voltage applied to the input to 5 Volts, and an input of maximum 35V is provided. Similarly, there are four condensers (9) in the preferred embodiment. The condensers (9) used are preferably filter condensers of 220 pF/50V, 100 pF/50V, 100 pF/25V and 47 pF/25V. Said power jack (8) is preferably a DC Power Jack of 2.1 mm.

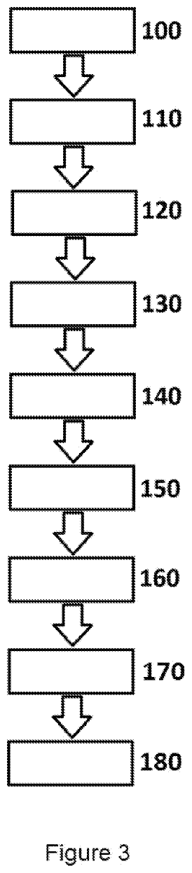

In case of the electronic and software system of the invention, a work flow is performed according to the flow chart shown in FIG. 3. Accordingly, the invention comprises the following process steps when considered as an industrial washing method:
100—Turning on the machine and enabling the electronic device,
110—Turning on the WiFi module,
120—Making the wireless network connection and requesting scanning of the card from the operator,
130—Scanning the card by the operator and sending the card information to the server,
140—Scanning the barcode of the product and sending the product information to the server,
150—Approving the recipe,
160—Loading the products and starting the washing process,
170—Loading the chemicals,
180—Unloading the products.

The process details of the general scheme above are provided below.

Step of Turning on the Machine and Enabling the Electronic Device (100)

In this step, the machine is turned on, and the electronic device (6) is enabled. Herein, the machine is a washing machine (1), but may vary depending on the sector or field of manufacture to which the system is applied.

Step of Turning on the WiFi Module (110)

The wifi module (14) is turned on, and the system is made ready for the functions such as sending/receiving information to/from the system, updating, etc.

Step of Making the Wireless Network Connection and Requesting Scanning of the Card from the Operator (120)

In this step, a wireless connection is made, and the operator is asked to scan the card through the Rfid reader module (11) in order to the record the operator who performs the operation.

Step of Scanning the Card by the Operator and Sending the Card Information to the Server (130)

In this step, after the operator scans the card through the Rfid reader module (11), the card information is sent to the fixed server (3) and then, to the central server (4). Thus, the information of the operator who conducts the operation is obtained.

Step of Scanning the Barcode of the Product and Sending the Product Information to the Server (140)

Information is identified in the barcode, such as order number, lot number, etc. of the product. In this step, the barcode on the label is scanned through the barcode reader, and the product information is sent to the fixed server (3) and then, to the central server (4) via the wifi module (14). The scanning process is carried out by the communication protocols via the device. The barcode reader does not need to be shown in the drawings. Preferably, it is positioned near the washing machine.

Step of Approving the Recipe (150)

The washing recipe is displayed on the user display (5a) after the steps of scanning the barcode of the products and sending the product information to the server (140). Upon approval of the washing recipe by the operator, the guidance instructions, such as “open the door”, “load the products”, etc., are displayed on the user display (5a). In this step, the operator does not approve the recipe and may select a different recipe, or may enter data.

Step of Loading the Products and Starting the Washing Process (160)

After approval of the recipe (150), the operator opens the door and loads the products according to the guidance instruction displayed on the user display (5a), so that the washing process is started.

Step of Loading Chemicals (170)

In this step, information on the chemical substance required for the washing process and the amount of that substance is displayed on the user display (5a). The operator will load and approve the chemical according to the instruction on the user display (5a).

Step of Unloading the Products (180)

After the washing process is performed according to the recipe defined for the product, the washing machine (1) will fall over. Before falling over, a warning note will be displayed on the user display (5a) that the machine will fall over. This warning is important for the safety of the employees working near the machine. The operator who has seen and approved the warning note will unload the products upon falling over of the washing machine (1). After the products are unloaded, a warning note will be displayed on the user display (5a) that the machine will return back to the previous position thereof, and the washing machine (1) will return back to its previous position prior to falling over upon the approval of the operator.

### INDUSTRIAL APPLICABILITY OF THE INVENTION

The industrial washing system of the invention has been already designed to be integrated into the production line of the textile companies, or to generate a new production line. The production lines will be integrated into the existing system in line with the modernized production purposes within the Industry 4.0 revolution, and the existing system will be made smart, efficient, modern and monitorable from a center. The system may be applied in other sectors, as well as all areas of textile.

1. A system comprising at least one washing machine, at least one user display connected to said washing machine, and a PLC which controls both said washing machine and the operation and is located in said washing machine, wherein the system comprises: a PLC system having the Profinet and TCP Modbus communication protocols which control the washing machine and the operation; at least one electronic device connected to said PLC (2) system and the washing machine, which manages said washing machine during the check (approval) of an employee; at least one user display on which the outputs, such as a recipe, a written warning, etc., are displayed, wherein the user display is connected to said electronic device and the PLC system; at least one wired or wireless fixed server which sends and receives information to/from said washing machine; at least one central server connected to said fixed server; at least one database in which the recipe and operation information is stored, in said fixed server and thus, in the central server; and at least one main screen connected to said central server.

2. A system according to claim 1, wherein the washing machine is a textile machine, or a machine tool and a workbench.

3. An industrial washing method comprising the following steps:
turning on a machine and enabling an electronic device,
turning on a WiFi module,
making a wireless network connection and requesting scanning of a card from an operator,
scanning the card by the operator and sending card information to a server,
scanning a barcode of a product and sending product information to a server,
approving a recipe,
loading the products and starting the washing process,
loading chemicals, and
unloading the products.

4. A method according to claim 3, wherein the method comprises the steps of turning on the machine and enabling the electronic device in the steps of turning on the machine and enabling the electronic device.

5. A method according to claim 3, wherein the method comprises the step of making the system ready for performing the functions, such as sending/receiving data to/from the system, by turning on the WiFi module during the step of turning on the WiFi module.

6. A method according to claim 3, wherein the method comprises the steps of making the wireless connection and requesting scanning of the card through the Rfid reader module from the operator, during the steps of making the wireless network connection and requesting scanning of the card from the operator.

7. A method according to claim 3, wherein the method comprises the steps of scanning the card through the Rfid reader module by the operator and sending the card information to a fixed server and then to a central server, during the steps of scanning the card by the operator and sending the card information to the server.

8. A method according to claim 3, wherein the method comprises the steps of scanning the barcode on the label through the barcode reader, sending the product information to the fixed server and then to the central server via the wifi module and performing the scanning process by the communication protocols via the device, during the steps of scanning the barcode of the products and sending the product information to the server.

9. A method according to claim 3, wherein the method comprises the steps of displaying the washing recipes on a user display and approving the washing recipes by the operator during the step of approving the recipe after the steps of scanning the barcode of the products and sending the product information to the server.

10. A method according to claim 9, wherein the method comprises the steps of selecting a different recipe or entering the data by the operator, during the step of approving the recipe.

11. A method according to claim 3, comprising the steps of opening the door, loading the products and starting the washing process by the operator according to the guidance recipes displayed on a user display, during the steps of loading the products and starting the washing process after the step of approving the recipe.

12. A method according to claim 3, wherein the method comprises the steps of displaying information on the required chemical substance and the amount of that substance to be used on a user display, loading the chemical substance by the operator according to the recipe on the user display and performing the approval process, during the step of loading chemicals.

13. A method according to claim 3, wherein the method comprises the steps of falling over the washing machine after the washing process is performed according to the recipe defined for the product, displaying a warning note on a user display before the machine falls over that the machine will fall over, approving the warning note by the operator, falling over the washing machine, unloading the products by the operator, displaying a warning note on the user display that the machine will return to the previous position after unloading the products, and returning the washing machine back to the previous position before falling over upon the approval of the operator, during the step of unloading the products.
